(19) United States
(12) Patent Application Publication
(10) Pub. No.: US 2015/0051943 A1
(43) Pub. Date: Feb. 19, 2015

(54) SYSTEM AND METHOD OF INTEGRATING DEVICE DATA WITH CUSTOMER RELATIONSHIP MANAGEMENT

(71) Applicant: Digi International Inc., Minnetonka, MN (US)

(72) Inventor: Larry Jovanovic, Chicago, IL (US)

(73) Assignee: Digi International Inc., Minnetonka, MN (US)

(21) Appl. No.: 13/968,073

(22) Filed: Aug. 15, 2013

(51) Int. Cl. G06Q 10/06

(52) U.S. Cl. CPC G06Q 10/06316
USPC 705/7.26

(57) ABSTRACT

A method of integrating device data into a customer relationship management (CRM) application comprises retrieving configuration data of the CRM application from a data storage device; retrieving device data associated with one or more devices from a device management system; and generating user-selectable options of a workflow configuration for the retrieved device data, the user-selectable workflow configuration options based on the retrieved configuration data of the CRM application. The method also comprises creating the workflow configuration based on user selections of the user-selectable options; and processing device data from the device management system according to the workflow configuration for the retrieved device data.

### BACKGROUND

Customer Relationship Management (CRM) is a service for managing an organization's current and future clients or customers. CRM applications can include functionality for providing customer support, marketing data, sales information, etc. In addition, some CRM applications are hosted on the web and accessed by a remote user.

### SUMMARY

In one embodiment, a method of integrating device data into a customer relationship management (CRM) application is provided. The method comprises retrieving configuration data of the CRM application from a data storage device; retrieving device data associated with one or more devices from a device management system; and generating user-selectable options of a workflow configuration for the retrieved device data, the user-selectable workflow configuration options based on the retrieved configuration data of the CRM application. The method also comprises creating the workflow configuration based on user selections of the user-selectable options; and processing device data from the device management system according to the workflow configuration for the retrieved device data.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a high level block diagram depicting one embodiment of an exemplary system for integrating device data with customer relationship management.

FIG. 2 is a high level block diagram depicting another embodiment of an exemplary system for integrating device data with customer relationship management.

FIG. 3 depicts an exemplary prompt for requesting user input to configure a machine process or workflow configuration.

FIG. 4 is a flow chart depicting one embodiment of an exemplary method of integrating device data with customer relationship management.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

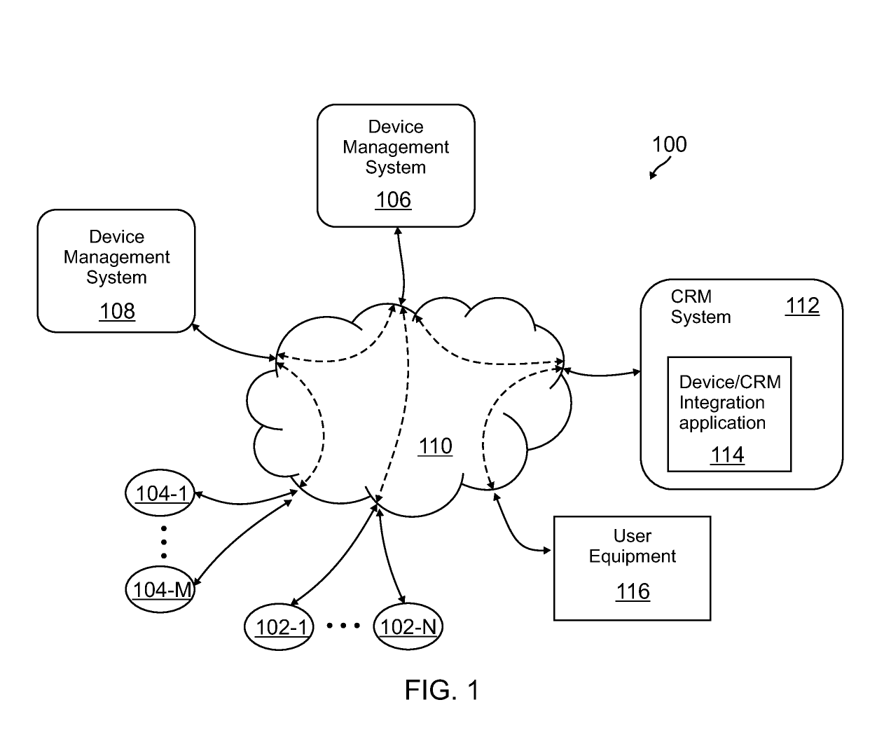

FIG. 1 is a high level block diagram of a system 100 for integrating device data with a Customer Relationship Management (CRM) application. In the embodiment shown in FIG. 1, system 100 includes a first plurality of devices 102-1 . . . 102-N (also referred to herein as devices 102), an optional second plurality of devices 104-1 . . . 104-M, a first device management system 106, an optional second device management system 108, a CRM system 112, and user equipment 116. Respective elements of system 100 are coupled together over network 110 as shown in FIG. 1. In this example, network 110 is implemented as a public wide area network, such as the Internet. However, in other embodiments, network 110 includes multiple networks. For example, in one alternative embodiment, network 110 includes a private local area network over which devices 102 are coupled to the first device management system 106 and a public wide area network over which the first device management system 106 is coupled to the CRM system 112.

As used herein, a device can include any component configured to measure or collect data and to communicate the measured data over a network. For example, a device can include, but is not limited to, a sensor (e.g. temperature sensors, pressure sensors, fluid level sensors, etc.), navigation equipment (e.g. altimeter, accelerometer, Global Navigation Satellite System receiver, etc.), a timer, and so forth. In addition, the devices 102 are configured to communicate the measured data using wired and/or wireless communication technologies, such as, but not limited to, Wi-Fi communication, cellular communication, satellite communication, fiber optic cables, and/or copper wiring, etc.

In addition, each of the devices 102 can communicate with the first device management system 106 over the network 110 using one of a plurality of connectivity options. One exemplary connectivity option involves integrating connectivity hardware into a device 102 to enable communication with the first device management system 106. Another exemplary connectivity option involves adding a connector or module to existing hardware of devices 102 to enable communication with the first device management system 106. Yet another exemplary connectivity option involves leveraging Application Programming Interfaces (APIs) of the device management system 106 to enable interaction between the devices 102 and the device management system 106. The device management system 106 receives and processes the data from the devices 102. In addition, the device management system 106 can implement various management functions, such as, but not limited to, issuing commands to reboot, providing firmware or software updates, etc. One exemplary device management system which can be implemented in system 100 is Device Cloud by Etherios. However, it is to be understood that other device management systems can be used.

System 100 also includes a Customer Relationship Management (CRM) system 112 which is coupled to user equipment 116 over network 110. One exemplary CRM system which can be implemented in system 100 is the CRM application provided by Salesforce.com, Inc. However, it is to be understood that other CRM systems can be used. The CRM system 112 implements or executes a device/CRM integration application 114. For example, in this example, the device/CRM integration application 114 is a separate application from a CRM application executed by the CRM system 112. The device/CRM integration application 114 establishes a connection with the device management system 106 over network 110 using security credentials, such as username, password, etc., received from user equipment 116.

After establishing the connection with the device management system 106, the device/CRM integration application 114 retrieves and stores device data from the device management system 106. The device/CRM integration application 114 also periodically synchronizes stored device data with updated device data from the device management system 106. The device/CRM integration application 114 also communicates the retrieved device data to the user equipment 116 over the network 110. In addition to providing the device data to the user equipment 116, in some embodiments, the device/CRM integration application 114 integrates the device data into an existing configuration of a CRM application, as described in more detail below. In particular, the device/CRM integration application 114 enables a user to create a workflow configuration for processing the device data based on an existing configuration of the CRM application. Thus, in addition to providing the device data to user equipment 116, the device/CRM integration application 114 leverages the existing CRM configuration which reduces complexity in creating a workflow configuration for the device data. As used herein, the term workflow configuration (also referred to herein as machine process) refers to rules and actions for processing device data. Alternatively, new workflow configurations can also be created with the device/CRM integration application 114 that are not based on an existing CRM configuration. In such embodiments, it is not necessary for the device/CRM integration application 114 to retrieve existing CRM configuration data.

In some embodiments, the act of configuring workflows occurs in the CRM system 112. In other embodiments, the act of configuring workflows occurs in the device management system 106. That is, the device/CRM application 114 enables a user to interact with the device management system 106 to manage/create workflow configurations within the device management system 106. The device/CRM application 114 is then configured to push the instruction sets corresponding with the workflow configurations from the device management system 106 into the CRM system 112. Thus, in such embodiments, the device management system 106 serves as a centrally located workflow configuration utility for pushing the corresponding instructions sets to one or more CRM systems. When more than one CRM system interacts with the device management system 106 via a respective device/CRM application 114, the CRM systems can be a heterogeneous set of different CRM systems. Thus, in such embodiments, the device/CRM application 114 enables interaction with the device management system 106 via the CRM system 112 and enables pushing instruction sets from the device management system 106 to the CRM system 112.

In this example, system 100 also includes the optional second device management system 108 which receives and manages device data from the second plurality of devices 104-1 . . . 104-M. The second device management system 108 can have similar or different management capabilities than first device management system 106. The CRM system 112 is coupled to the second device management system 108 via the first device management system 106. That is, the first device management system 106 acts as a pass-through to deliver data from the second device management system 108 to the device/CRM integration application 114 in CRM system 112. In addition, in some embodiments, the first device management system 106 acts as a pass through for device commands sent from the device/CRM integration application 114 to the second device management system 108. Hence, in this example, the device/CRM integration application 114 can integrate devices 104 and devices 102 with the CRM system regardless of the device management system which manages the respective devices. Alternatively, the device/CRM integration application 114 can couple directly to the optional second device management system 108 rather than using the first device management system 106 as a pass-through.

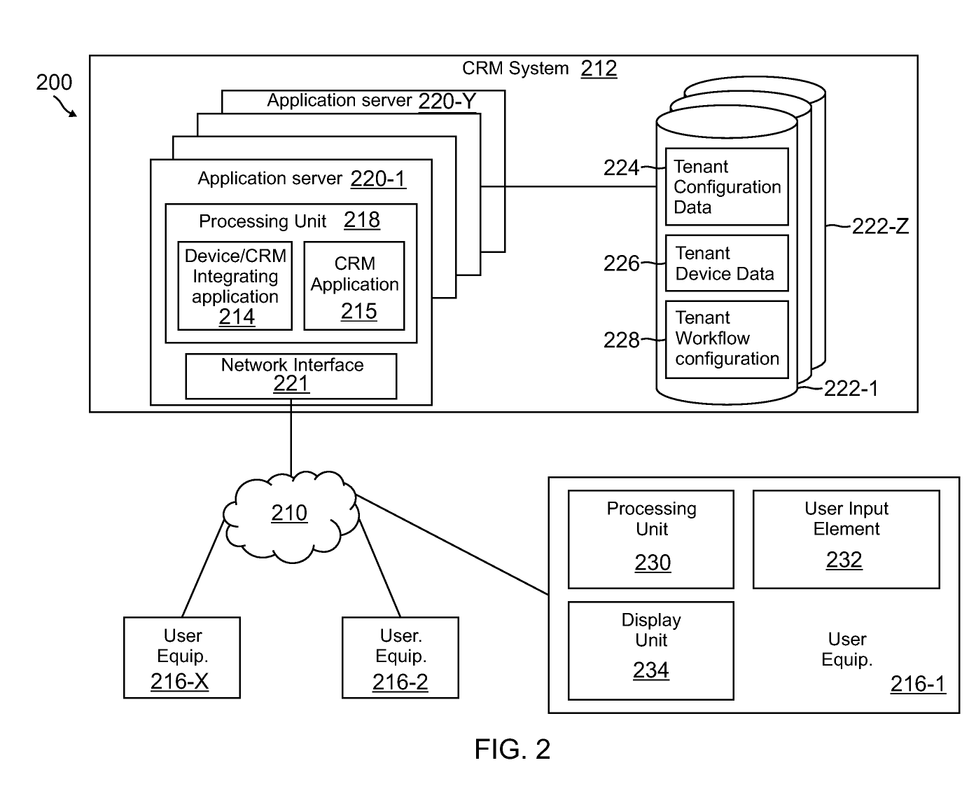

FIG. 2 is a high level block diagram depicting details of CRM system 212 and user equipment 216-1 in another embodiment of an exemplary system 200 for integrating device data with customer relationship management. System 200 includes a plurality of user equipment 216-1 . . . 216-X coupled to a CRM system 212 via network 210, such as the Internet. For purposes of explanation, only details of user equipment 216-1 are depicted in FIG. 2. However, it is to be understood that user equipment 216-2 . . . 216-X operate similarly to user equipment 216-1 and comprise similar components. As shown in FIG. 2, user equipment 216-1 includes a processing unit 230, a user input element 232 and a display unit 234. The display unit 234 can be implemented as any suitable display element capable of rendering a visual display, such as, but not limited to, a cathode ray tube (CRT) display, an active matrix liquid crystal display (LCD), or a passive matrix LCD. The user input element 232 can be implemented with an element that is separate from the display unit 234, such as, but not limited to, a keyboard, electronic mouse, joystick, etc. Alternatively, the user input element 232 can be implemented together with the display unit 234 via a touch screen for display and input of user data. In addition, it is to be understood that user equipment 216-1 may include other components not shown or described herein.

In this example, the CRM system 212 includes a plurality of application servers 220-1 . . . 220-Y that are each configured to run or execute applications in order to provide data, forms, webpages, etc. to the respective user equipment 216. In addition, the application servers 220-1 . . . 220-Y retrieve data from and store data to a plurality of data storage devices 222-1 . . . 222-Z. For purposes of explanation, only details of application server 220-1 are shown and described. However, it is to be understood that each application server 220 operates similarly. The application server 220-1 includes a processing unit 218 and a network interface 221. The network interface 221 is configured to couple the application server 220-1 to the network 210, as understood by one of skill in the art.

The processing unit 218 can include one or more central processing units (CPU), microcontrollers, microprocessors (e.g., a digital signal processor (DSP)), field programmable gate arrays (FPGA), application specific integrated circuits (ASIC) and other processing devices. In addition, the processing unit 218 unit includes or functions with software programs, firmware or other computer readable instructions for carrying out various methods, process tasks, calculations, and control functions, used in the integrating device data with a CRM application.

The instructions or applications executed by the processing unit 218 are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc.

In particular, in this example, the processing unit 218 executes Device/CRM integration application 214 and CRM application 215. Hence, the instructions for Device/CRM integration application 214 and CRM application 215 can be stored on a memory device included in the application server 220-1 or on a memory device external to the application server 220-1 such as one of the plurality of data storage devices 222-1 . . . 222-Z. In this example, Device/CRM integration application 214 is separate from CRM application 215. In other words, Device/CRM integration application 214 can be referred to as a third-party application or plug-in which works with the CRM application 215. However, in other embodiments, the functionality of Device/CRM integration application 214 is included as a part or module of the CRM application 215.

In addition, it is to be understood that the depiction and description of application server 220-1 has been simplified for purposes of explanation. For example, it is to be understood that application server 220-1 can include other components and run additional applications not shown in FIG. 2. Similarly, it is to be understood that the respective depictions of database 222-1 and user equipment 216-1 have been simplified for purposes of explanation.

Furthermore, in this example, the CRM system 212 is implemented using a multi-tenant architecture. That is, multiple users are served by the same instance of an application running on the same application server 220. Each tenant's respective data is stored on one of the data storage devices 222 and is not shared with other tenants. However, it is to be understood that multiple instances of an application can be executed on a plurality of servers, where each instance serves a plurality of tenants. In addition, in other embodiments, the CRM system 212 is implemented using a multi-instance architecture where each instance serves a single user.

In operation, each of one or more user equipment 216-1 . . . 216-X communicates with one or more application servers 220-1 . . . 220-Y via the network 210. Each of user equipment 216-1 . . . 216-X can be implemented as any device suitable to communicate over a network, such as, but not limited to, desktop computers, laptop computers, slate or tablet computers, wireless telephones (including so-called “smart phones”), personal media players, etc. In order to obtain device data from a device management system, the Device/CRM integration application 214 provides a prompt to processing unit 230 in the user equipment 216-1 for display on the display unit 234. The displayed prompt requests security credentials for the device management system, such as username and password.

A user provides the requested security credentials via the user input element 232 and the processing unit 230 directs communication of the security credentials to the device/CRM integration application 214 in application server 220-1. In some embodiments, the collection of security credentials occurs once and the security credentials are then stored for later use, such as updating/synchronizing device data. In other embodiments, the request for security credentials can occur periodically, such as at the start of each session.

The processing unit 218 executing the device/CRM integration application 214 establishes a connection with the device management system and retrieves device data. In particular, in this example, the device/CRM integration application 214 implements a Representational State Transfer (REST) architecture. For example, the device/CRM integration application 214 implements RESTful web application programming interfaces (APIs) to discover configuration of the device management system, obtain monitor/alarm definitions, and monitor state of the devices. However, it is to be understood that other architecture, such as Simple Object Access Protocol (SOAP), can be used in other embodiments. In addition, it is to be understood that functions or actions performed by the device/CRM integration application 214 involve execution of the device/CRM integration application 214 by the processing unit 218 in conjunction with other components such as input/output (I/O) interfaces, etc.

The retrieved device data is stored as tenant device data 226 in database 222-1. Thus, in the multi-tenant architecture used in this example, the device data is only available to the respective tenant. It is to be understood that a tenant can include multiple users associated with the same organization. Thus, each user can log in and have access to shared tenant data based on the configuration of the CRM application 215, as understood by one of skill in the art.

The device/CRM integration application 214 directs communication of the device data to the user equipment 220-1. In some embodiments, raw device data is communicated to the user equipment 220-1. In other embodiments, the raw device data is analyzed and the results of the analysis are communicated to the user equipment 220-1. Thus, the device data communicated to the user equipment 220-1 can include raw device data and/or analyzed device data. For example, in one embodiment, the device data can include raw temperature measurements and/or alarm data based on comparing the raw temperature measurements to a threshold. The analysis can be performed by the device management system or by the device/CRM integration application 214.

In addition to providing device data to the user equipment 220-1, the device/CRM integration application 214 enables a user to customize machine processes, also referred to herein as workflow configuration, based on existing configuration of the CRM application 215. A machine process comprises one or more rules for processing device data received from the device management system. In particular, the device/CRM integration application 214 retrieves tenant configuration data 224 for the CRM application 215 from data storage device 222-1. As used herein, configuration data for a CRM application is defined to mean user customizable data used by the CRM application, including default values and customized values. For example, CRM application configuration data can include attributes such as user roles, types of available actions, priority level, record types, etc.

Based on the configuration data 224 for the CRM application 215, the device/CRM integration application 214 generates user-selectable options of a workflow configuration for the retrieved device data. For example, in one embodiment, the device/CRM integration application 214 generates user-selectable options for actions to be taken under predetermined conditions, such as an alarm condition. Some exemplary actions include creating a message board post, creating a new case, or creating a sales opportunity record. These action options can be generated based on the configuration of the CRM application. In addition, attributes for each action can be generated based on the configuration of the CRM application. For example, Table 1 depicts exemplary options/attributes for creating a new case that are based on configuration of a CRM application. It is to be understood that the options discussed herein are presented by way of example only and that other options can be generated based on configuration data for a CRM application and that such options are dependent on the specific CRM application configuration.

TABLE 1

| ATTRIBUTE | VALUES |
|---|---|
| Record Type | Closed Case |
| | Open Case |
| Record Owner | Account Owner |
| | Assignment Rules |
| | Specific Owner |
| Priority | High |
| | Normal |
| | Low |
| Case Origin | email |
| | phone |
| | web |
| | Integration application |

As shown in Table 1, each attribute is associated with multiple possible values. For example, the attribute Record Owner can be assigned based on a default account owner, on assignment rules determined by the CRM application configuration, or based on specified owner. The default account owner, assignment rules, and the options for a specific owner can also be selected from a list based on the CRM application configuration data. Hence, the actions, attributes, and alternative values of the respective attributes can be generated from the CRM application configuration data 224. Thus, a user can leverage the existing CRM application configuration without having to reenter information or perform time-consuming coding and porting of information.

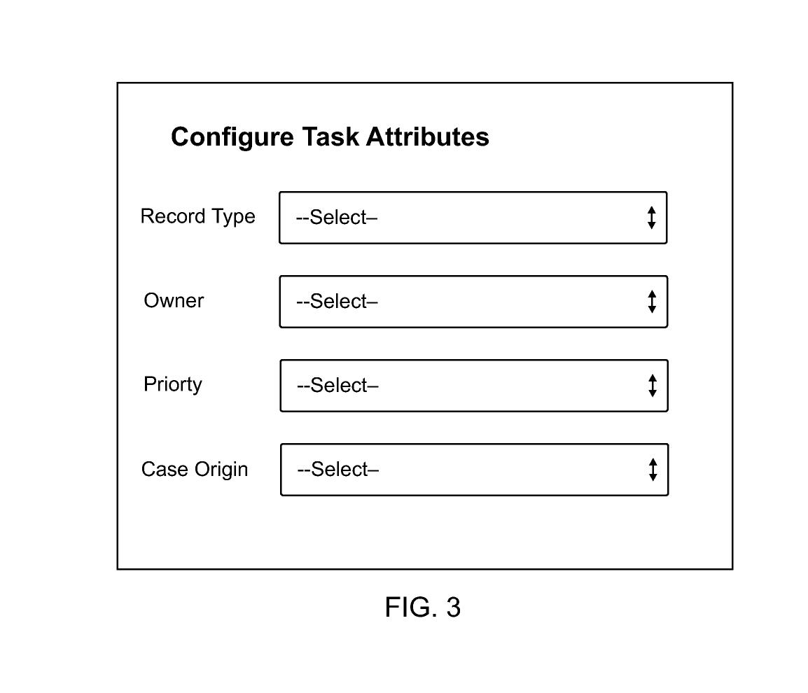

The device/CRM integration application 214 provides one or more prompts to a user via the user equipment 216. The prompts are displayed on the display unit 234 and the user makes selections via the user input element 232. The prompts guide a user in selecting actions, attributes and attribute values in configuring a machine process. In addition, the prompts can be displayed as “pop-up” windows overlaying other information on the display unit 234. For example, FIG. 3 depicts an exemplary prompt for requesting user input to configure a machine process or workflow configuration. The prompt shown in FIG. 3 corresponds to options listed in Table 1. However, it is to be understood that other options/attributes can be displayed in other embodiments. As shown in this example, a drop down menu is provided for each attribute enabling a user to select from values based on the existing CRM configuration data. However, it is to be understood that other formats can be used for prompts, such as bulleted lists, text blocks with auto-complete, etc. The user selections are communicated to the device/CRM integration application 214 which creates and stores the machine process.

As device data is periodically retrieved from the device management system, the device/CRM integration application 214 executes the configured machine processes to respond to the device data accordingly. For example, a machine process can be configured to send out notification in response to an alarm condition. Such notifications can be sent via email, phone, text message, message board, etc. Hence, notifications can include, but are not limited to, an email message, a text message, a message board post, or an automated phone message. Additionally, a machine process can be configured to send commands to a device via the device management system to reboot the device, download firmware updates, or other action without human intervention. It is to be understood that the above actions are presented by way of example and that other actions can be configured in a machine process. In addition, the machine processes can be configured to execute based on triggers other than alarm conditions, such as, but not limited to, version information, time since install, etc.

In addition, the device/CRM integration application 214 can enable a user to organize the devices into groups. In particular, the device/CRM integration application 214 can present a user with options to create a new group and/or to use an existing group based on the CRM configuration data. For example, configuration of the CRM application 215 may include groups based on geographic region. In such situations, the device/CRM integration application 214 can present options to assign devices to one of the groups from the CRM configuration data based on geographic region.

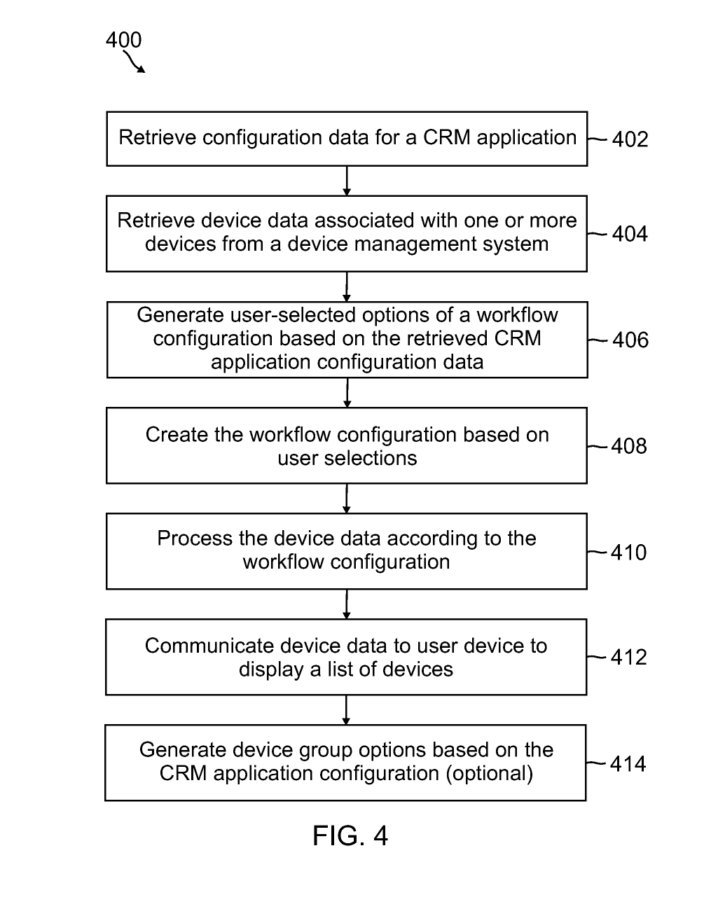

FIG. 4 is a flow chart depicting a method 400 of integrating device data into a customer relationship management application. Method 400 can be implemented, for example, via a device/CRM application integration application in a system such as system 100 or system 200 described above. At block 402, configuration data for a CRM application is retrieved from a data storage device. At block 404, device data associated with one or more devices is retrieved from a device management system. In particular, a connection can be established via web APIs as discussed above. In addition, retrieving device data can include performing an initial migration of data from the device management system followed by periodic updates of the device data. The initial migration of data includes discovering devices and registering them with the CRM application. The periodic updates can be implemented by periodically requesting an update from the device management system in some embodiments. In other embodiments, the device management system is configured to push updates to the device/CRM integration application.

At block 406, user-selectable options of a workflow configuration for the retrieved device data are generated based on the retrieved configuration data of the CRM application, as discussed above. Alternatively, as stated above, in some embodiments, the user-selectable options are not based on retrieved configuration data of the CRM application. At block 408, the workflow configuration is created based on user selections of the user-selectable options. In other words, the generated user-selectable options are presented to a user, such as in a pop-up window, as discussed above. The user selects from the options and the values selected by the user are used to create the workflow configuration. In some embodiments, creating the workflow configuration comprises communicating the user-selected values to the device management system to create the workflow configuration in the device management system. The workflow configuration is then imported into the CRM application by the device/CRM integration application. For example, instructions sets corresponding to the workflow configuration can be imported into the CRM application.

At block 410, the device data is processed according to the workflow configuration. For example, as device data is initially received and/or updated, the workflow configuration is used to process the data. Processing the device data according to the workflow configuration can include sending a notification to one or more users based on the workflow configuration or sending a command to at least one of the one or more devices associated with the device data based on the workflow configuration, for example. Sending a notification can include, but is not limited to, sending an email message, sending a text message, or creating a message board post. Sending a command to at least one of the devices can include sending a command to reboot, power down, update firmware, etc.

At block 412, retrieved device data is communicated to a user device, such as user equipment 216 described above, for displaying a list of devices on a display unit. At block 414, device group options are optionally generated based on the CRM application configuration, as discussed above. A user is able to select from the device group options to assign the devices to groups. Alternatively, the devices can be assigned to groups automatically based on the retrieved device data. It is to be understood that the above steps can be performed simultaneously or in an order different the order in which the steps are described.

### Example Embodiments

Example 1 includes a method of integrating device data into a customer relationship management (CRM) application, the method comprising: retrieving configuration data of the CRM application from a data storage device; retrieving device data associated with one or more devices from a device management system; generating user-selectable options of a workflow configuration for the retrieved device data, the user-selectable workflow configuration options based on the retrieved configuration data of the CRM application; creating the workflow configuration based on user selections of the user-selectable options; and processing device data from the device management system according to the workflow configuration for the retrieved device data.

Example 2 includes the method of Example 1, wherein processing device data includes sending a notification to one or more users based on the workflow configuration.

Example 3 includes the method of any of Examples 1-2, wherein creating the workflow configuration comprises: outputting user selections of the user-selectable options to the device management system to create the workflow configuration in the device management system; and importing the workflow configuration in the CRM application.

Example 4 includes the method of any of Examples 1-3, wherein processing device data includes sending a command to at least one of the one or more devices associated with the device data based on the workflow configuration.

Example 5 includes the method of any of Examples 1-4, further comprising displaying a list of the one or more devices associated with the device data.

Example 6 includes the method of Example 5, further comprising grouping the one or more devices into a plurality of groups based on the retrieved configuration data of the CRM application.

Example 7 includes the method of any of Examples 1-6, wherein retrieving the device data from the device management system comprises: performing an initial migration of device data from the device management system to the CRM application; and periodically updating device data retrieved from the device management system.

Example 8 includes the method of any of Examples 1-7, wherein retrieving device data comprises retrieving device data from the device management system via one or more web application programming interfaces (APIs).

Example 9 includes a program product comprising a non-transitory processor-readable medium on which program instructions are embodied, wherein the program instructions are configured, when executed by at least one programmable processor, to cause the at least one programmable processor to: establish communication with a device management system to retrieve device data associated with one or more devices from the device management system; output commands to a display unit to display one or more user-selectable options of a workflow configuration for the retrieved device data; communicate received user input indicating selections of the user-selectable options to the device management system to create the workflow configuration in the device management system; and import the workflow configuration from the device management system into a Customer Relationship Management (CRM) application to process device data from the device management system according to the workflow configuration for the retrieved device data.

Example 10 includes the program product of Example 9, wherein the program instructions are further configured to cause the at least one programmable processor to retrieve configuration data of the CRM application from a data storage device associated with the CRM application; wherein, the user-selectable workflow configuration options are based on the retrieved configuration data of the CRM application.

Example 11 includes the program product of any of Examples 9-10, wherein the program instructions are further configured to cause the at least one programmable processor to output a command to at least one of the one or more devices associated with the device data based on the workflow configuration.

Example 12 includes the program product of any of Examples 9-11, wherein the program instructions are further configured to cause the at least one programmable processor to: output commands to display one or more group options based on configuration data of the CRM application; and associate the one or more devices with the one or more groups based on user input.

Example 13 includes the program product of any of Examples 9-12, wherein the program instructions are further configured to: perform an initial migration of device data from the device management system to the CRM application; and periodically update device data retrieved from the device management system.

Example 14 includes the program product of any of Examples 9-13, wherein the program instructions are further configured to retrieve device data from the device management system via one or more web application programming interfaces (APIs).

Example 15 includes a system comprising: an application server comprising a processing unit configured to execute a customer relationship management (CRM) application; a data storage device configured to store configuration data for the CRM application; and a network interface configured to couple the application server to a network; wherein the application server is configured to establish a connection with a device management system over the network and retrieve data associated with one or more devices from the device management system; wherein the application server is further configured to generate prompts containing one or more user-selectable options based on the CRM application configuration data and to provide the prompts to a user device over the network; wherein the application server is further configured to create a workflow configuration for processing device data received from the device management system based on options selected by a user from the one or more user-selectable options.

Example 16 includes the system of Example 15, wherein the application server is configured to create, based on the options selected by the user, a workflow configuration that defines criteria for sending a notification to one or more users.

Example 17 includes the system of any of Examples 15-16, wherein the application server is configured to create a workflow configuration, based on the options selected by the user, that defines criteria for sending a command via the device management system to at least one of the one or more devices.

Example 18 includes the system of any of Examples 15-17, wherein the application server is configured to retrieve the device data from the device management system via one or more Representational State Transfer (REST) web application programming interfaces (APIs).

Example 19 includes the system of any of Examples 15-18, wherein the application server is configured to generate device group options based on the CRM application configuration data.

Example 20 includes the system of any of Examples 15-19, wherein the application server is configured to perform an initial migration of device data from the device management system and subsequently to perform periodic updates of the migrated device data.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method of integrating device data into a customer relationship management (CRM) application, the method comprising:
retrieving configuration data of the CRM application from a data storage device;
retrieving device data associated with one or more devices from a device management system;
generating user-selectable options of a workflow configuration for the retrieved device data, the user-selectable workflow configuration options based on the retrieved configuration data of the CRM application;
creating the workflow configuration based on user selections of the user-selectable options; and
processing device data from the device management system according to the workflow configuration for the retrieved device data.

2. The method of claim 1, wherein processing device data includes sending a notification to one or more users based on the workflow configuration.

3. The method of claim 1, wherein creating the workflow configuration comprises:
outputting user selections of the user-selectable options to the device management system to create the workflow configuration in the device management system; and
importing the workflow configuration in the CRM application.

4. The method of claim 1, wherein processing device data includes sending a command to at least one of the one or more devices associated with the device data based on the workflow configuration.

5. The method of claim 1, further comprising displaying a list of the one or more devices associated with the device data.

6. The method of claim 5, further comprising grouping the one or more devices into a plurality of groups based on the retrieved configuration data of the CRM application.

7. The method of claim 1, wherein retrieving the device data from the device management system comprises:
performing an initial migration of device data from the device management system to the CRM application; and
periodically updating device data retrieved from the device management system.

8. The method of claim 1, wherein retrieving device data comprises retrieving device data from the device management system via one or more web application programming interfaces (APIs).

9. A program product comprising a non-transitory processor-readable medium on which program instructions are embodied, wherein the program instructions are configured, when executed by at least one programmable processor, to cause the at least one programmable processor to:
establish communication with a device management system to retrieve device data associated with one or more devices from the device management system;
output commands to a display unit to display one or more user-selectable options of a workflow configuration for the retrieved device data;
communicate received user input indicating selections of the user-selectable options to the device management system to create the workflow configuration in the device management system; and
import the workflow configuration from the device management system into a Customer Relationship Management (CRM) application to process device data from the device management system according to the workflow configuration for the retrieved device data.

10. The program product of claim 9, wherein the program instructions are further configured to cause the at least one programmable processor to retrieve configuration data of the CRM application from a data storage device associated with the CRM application; wherein, the user-selectable workflow configuration options are based on the retrieved configuration data of the CRM application.

11. The program product of claim 9, wherein the program instructions are further configured to cause the at least one programmable processor to output a command to at least one of the one or more devices associated with the device data based on the workflow configuration.

12. The program product of claim 9, wherein the program instructions are further configured to cause the at least one programmable processor to:
output commands to display one or more group options based on configuration data of the CRM application; and
associate the one or more devices with the one or more groups based on user input.

13. The program product of claim 9, wherein the program instructions are further configured to:
perform an initial migration of device data from the device management system to the CRM application; and
periodically update device data retrieved from the device management system.

14. The program product of claim 9, wherein the program instructions are further configured to retrieve device data from the device management system via one or more web application programming interfaces (APIs).

15. A system comprising:
an application server comprising a processing unit configured to execute a customer relationship management (CRM) application;
a data storage device configured to store configuration data for the CRM application; and
a network interface configured to couple the application server to a network;
wherein the application server is configured to establish a connection with a device management system over the network and retrieve data associated with one or more devices from the device management system;
wherein the application server is further configured to generate prompts containing one or more user-selectable options based on the CRM application configuration data and to provide the prompts to a user device over the network;
wherein the application server is further configured to create a workflow configuration for processing device data received from the device management system based on options selected by a user from the one or more user-selectable options.

16. The system of claim 15, wherein the application server is configured to create, based on the options selected by the user, a workflow configuration that defines criteria for sending a notification to one or more users.

17. The system of claim 15, wherein the application server is configured to create a workflow configuration, based on the options selected by the user, that defines criteria for sending a command via the device management system to at least one of the one or more devices.

18. The system of claim 15, wherein the application server is configured to retrieve the device data from the device management system via one or more Representational State Transfer (REST) web application programming interfaces (APIs).

19. The system of claim 15, wherein the application server is configured to generate device group options based on the CRM application configuration data.

20. The system of claim 15, wherein the application server is configured to perform an initial migration of device data from the device management system and subsequently to perform periodic updates of the migrated device data.
